(19) United States
(12) Patent Application Publication
(10) Pub. No.: US 2021/0198074 A1
(43) Pub. Date: Jul. 1, 2021

(54) STACKING MACHINE FOR HANDLING INDIVIDUAL SHEETS AND A SHEET DISPENSING SYSTEM FOR PROVIDING INDIVIDUAL SHEETS

(71) Applicant: PAL-CUT A/S, Holstebro (DK)

(72) Inventors: Karsten Mosegaard, Holstebro (DK); Lars Ostergaard, Holstebro (DK); Johnny Larsen, Aalbong (DK); Rudi Pedersen, Herning (DK)

(73) Assignee: PAL-CUT A/S, Holstebro (DK)

(21) Appl. No.: 17/058,041

(22) PCT Filed: Sep. 14, 2018
(86) PCT No.: PCT/EP2018/074934

§ 371 Date: Nov. 23, 2020

(30) Foreign Application Priority Data
May 24, 2018 (EP) PCT/EP2018/063711

(51) Int. Cl. B65H 35/10; B26D 1/06; B26D 1/18; B65H 23/04; B65H 29/24; B65H 31/10; B65H 35/08

(52) U.S. Cl. CPC B65H 35/10; B26D 1/065; B26D 1/185; B65H 23/048; B65H 29/241; B65H 2408/2171; B65H 35/08; B65H 2301/5151; B65H 2301/5155; B65H 2406/341; B65H 2406/342; B65H 31/10

(57) ABSTRACT

The present invention relates to a method of stacking individual sheets and a stacking machine for handling individual sheets, the stacking machine comprising a frame assembly (13) including support columns (711, 811) for supporting the delivery station (70), the transfer station (80) and the elevation station (82). The delivery station has a delivery table and the transfer station including a handling arm (85) is movable from a first position above the delivery table to a second position above the elevation station. The handling arm includes a holding member (86) for contacting the sheets individually and transferring the sheets individually from the delivery table to the elevation station and releasing the sheets individually at the elevation station. The elevation station has a platform for collecting the individual sheets and the platform is moved vertically from a first level to a second level for allowing the sheets to be stacked on top of the one another.

### TECHNICAL FIELD

The present invention relates to a sheet dispensing system for providing individual sheet of a cellulose fiber based material from a supply reel or web roll into the desired sheet dimension, said sheets being substantially straight after having been unrolled from the supply reel on which the cellulose fiber based web is supplied.

### BACKGROUND OF THE INVENTION

It has been known to use individual sheets of cardboard for laying between items stacked on a pallet in order for the stacked items on the pallet to be prevented from sliding or moving during transport of the item. The individual sheets used for laying between items are mostly dispensed from a supply reel of paper or cardboard, from where they are cut into the desired dimension.

Examples of sheet dispensers can be found in EP2789559 A1, U.S. Pat. No. 4,941,374 and WO 2004031058 A1. All of these publications describe dispensing of individual intermediate sheet layers, where the paper is rolled up on a supply reel from where it is fed to the sheet feeder of the sheet dispenser. After entering the sheet dispenser, the paper is cut into sheets of suitable length and the sheets are to be placed on pallets.

One of the disadvantages of these sheet dispensers are, that they do not have means for smoothing the unrolled paper, which would be necessary, as the sheets would inherently have a curvature after the paper is unrolled from the reel. This is due to the circumstance, that the paper or cardboard is delivered on a large supply reel, from which the web is unrolled and fed into the sheet dispensing machine.

Another drawback is that the known sheet dispensers do not have means for adjusting or compensating the degree of smoothing during the process of unrolling the paper from the paper reel (supply reel). This is necessary as the inherent curvature of the paper changes with the every changing diameter of the paper reel during the unrolling of the paper from the paper reel. As the paper starts to be unrolled from the paper reel, the curvature of the outer most layers of the paper on a large paper reel would be smaller compared to the curvature of the inner most layers of the paper near the final state of unrolling the paper from the reel. The curvature of the outer most layer on the paper reel does not need to be smoothened (straightened) to the same degree as the inner layer of the supply reel. Thereby, the need for smoothing of the cellulose-based material/web (paper or cardboard) varies during the process of dispensing the sheet layers.

The general object of the present invention is to provide a solution according to which smoothing is done dependent of the diameter of the supply reel or cardboard reel.

In accordance with a first aspect of the present invention provides a sheet dispensing system for dispensing individual sheets, said sheet dispensing system comprising a frame assembly, a reel loading station, a sheet dispenser station, and a delivery station,
said reel loading station, said sheet dispenser station, and said delivery station being supported individually or collectively by said frame assembly,
said reel loading station including a supply reel of a cellulose fiber based web and a support for supporting said supply reel and allowing the dispensing of said cellulose fiber based web from said supply reel,
said sheet dispenser station including a feeding mechanism and a cutting mechanism,
said feeding mechanism serving to receive said cellulose fiber based web from said reel loading station and having a tension roller and a feeding roller,
said cutting mechanism having a reciprocating cutter assembly for cutting said cellulose fiber based web into individual sheets when moved transversally relative to said cellulose fiber based web from a first position to a second position at opposite sides of said cellulose fiber based web,
said delivery station including a delivery table connected to said sheet dispenser station for receiving said individual dispensed sheets,

The present invention is primarily directed towards a sheet dispensing system for dispensing individual sheets and provides a system having said reel loading station or said sheet dispenser station or delivery station further comprising a smoothing mechanism having a first guide roller and second guide roller, said first and second guide rollers being adjustable in relation to one another for altering the smoothing angle dependent of the diameter of said supply reel in order to compensate for the curvature of said cellulose fiber based web and provide non-curved individual sheets.

Through the use of a smoothing mechanism it is possible to remove the curvature from the cellulose fiber based material for obtaining non-curved sheets. The smoothing mechanism may be implemented at any suitable position in the sheet dispensing system.

The advantageous aspect of the present invention is that the diameter of the reel is compensated during the process of unrolling the web from the supply reel, and the sheet dispenser station would therefore be fed with a cellulose fiber based web, which can be cut into sheets having the required dimensions.

A further advantage is that the smoothing of the cellulose fiber based material is performed during the process of dispensing the cellulose fiber based web.

A further advantage is that the individual sheets can be delivered to the delivery table, from where the handling of the individual sheets can easily be done by other equipment as the individual sheets would be straight and non-curved after being dispensed from the sheet dispenser station.

A further advantage is that the frame assembly for individually or collectively supporting said reel loading station, said sheet dispenser station, and said delivery station provides the possibility that the different unit would not have to be located in close vicinity of each other, which would be advantageous as the sheet dispensing system could be fitted into different production facilities, where the area of the ground floor could be utilized for other purpose.

The smoothing angle is the angle, which is established by adjustment of the position of the guide rollers. The smoothing angle is opposite the convex arc or the tangent line for the guide rollers. The smaller the smoothing angle is, the larger the contact surface would be and hereby, the contact surface of the cellulose fiber based web with the guide roller of the smoothing mechanism would be larger.

The tension of the cellulose fiber based web or material is established as the feeding mechanism starts drawing the cellulose fiber based web from the supply reel. The sheet dispensing system does not have means for controlling the tension in the web like a dancer roller connected to an individual controller.

The smoothening of the cellulose fiber based web could also be provided based on a measurement of the curvature of the cellulose fiber based web after it has been cut into individual sheets. The measurement could be performed by a sensor mounted on the delivery table.

According to the first aspect of the invention, said cutting mechanism is prevented from cutting when moved in the opposite direction from said second position to said first position.

According to the first aspect of the invention, said cutting mechanism is cutting when moved in the opposite direction from said second position to said first position.

According to the first aspect of the invention, said first and second guide rollers are adjustable in relation to one another for altering the smoothing angle by a mechanical suspension of the first guide roller and/or second guide. Through the use of a mechanical suspension of the first guide roller and/or second guide, it is possible to obtain a reliable mechanical construction, which can be mounted in different locations in the dispensing system.

According to the first aspect of the invention, said first and second guide rollers are adjustable in relation to one another for altering the smoothing angle by a mechanical coupling between the first guide roller and second guide roller. Through the use of a mechanical coupling between the first guide roller and the second guide roller it is possible to obtain a reliable mechanical construction, where the first guide can be fixed and the second guide roller can be adjusted relative to the first guide roller. The mechanical coupling facilitates for the mounting at different location in the dispensing system.

According to the first aspect of the invention, said first and second guide rollers are adjustable in relation to one another for altering the smoothing angle by the provision of an electronic controller controlling said first and second rollers in relation to one another in response to an electrical signal generated by a sensor mounted on the loading station or the delivery station. Through the use of an electronic controller and a sensor, it is possible to obtain adjustment of the smoothing mechanism where the electrical signal can be correlation and information of the cellulose fiber based web, which can be entered and used by the controller used operation of the sheet dispensing system.

According to the first aspect of the invention, said controller has an input channel and an out signal, said controller being capable of receiving a signal from a reel sensor connected to said reel loading station for generating said electrical signal being representative of the diameter of said supply reel. By using a controller, it is possible to obtain an operation of the sheet dispensing system, where adjustment of the smoothing mechanism is based on the signal from the reel sensor. Moreover, it is possible to operate the smoothing mechanism in dependency of the diameter of the supply reel.

According to the first aspect of the invention, said cellulose fiber based web is movable continuously, and said cutting mechanism is movable reciprocating in parallel with and in synchronism with said cellulose fiber based web during the cutting of said cellulose fiber based web into said individual sheets. By continuously feeding said cellulose fiber based web it is possible to obtain an “on the fly” cutting of the cellulose fiber based web and allowing sheets to be produced without intermittently stop.

According to a first aspect of the invention, said cellulose fiber based web is movable intermittently and said cutting mechanism is movable transversally relative to said cellulose fiber based web during the cutting of said cellulose fiber based web into said individual sheets. By intermittently feeding said cellulose fiber based web it is possible to obtain a more simple construction of the cutting mechanism, where the cutter assembly can be guided on a sledge mounted in the sheet dispensing station.

In accordance with a method according to a second aspect of the invention, the invention discloses a method of dispensing individual sheets by means of a sheet dispensing system comprising a frame assembly, a reel loading station, a sheet dispenser station, and a delivery station, said method comprising the following steps:
providing said frame assembly for individually or collectively supporting said reel loading station, said sheet dispenser station and said delivery station,
providing said reel loading station including a supply reel of a cellulose fiber based web and a support for supporting said supply reel,
providing said sheet dispenser station including a feeding mechanism and a cutting mechanism,
providing said feeding mechanism having a tension roller and a feeding roller,
providing said cutting mechanism having a reciprocating cutter assembly,
providing said delivery station connected to said sheet dispenser station,
providing a smoothing mechanism having a first guide roller and a second guide roller at said reel loading station or said sheet dispenser station or said delivery station,
dispensing said cellulose fiber based web to said feeding mechanism serving to receive said cellulose fiber based web from said reel loading station
cutting said cellulose fiber based web by moving said reciprocating cutter transversally relative to said cellulose fiber based web from a first position to a second position at opposite sides of said cellulose fiber based web and preventing cutting when moving said reciprocating cutter in the opposite direction from said second position to said first position,
adjusting said first or second guide rollers being adjustable in relation to one another, said guide rollers being adjustable for altering the smoothing angle dependent of the diameter of the supply reel in order to compensate for the curvature of said cellulose fiber based web and provide non-curved individual sheets.
dispensing said individual sheets on said delivery table of said delivery station

The term “smoothing mechanism” should in this context be understood as a mechanism, which is able to straighten the paper or cardboard from having a curvature relative to the longitudinal direction of the length of the paper.

The term “cellulose fiber based material” or “cellulose fiber based web” should in this context be understood as cellulose fiber material produced by pressing together moist fibres of cellulose pulp derived from wood, rags or grasses, and drying them into flexible sheets, e.g. commonly referred to as paper or carboard. The pulp could also contain non-wood material.

It is contemplated that the smoothing mechanism of the present invention may be utilized in other combinations with various foils such as polymer foils or sheets having an inherent “memory” to a smaller or larger degree, aluminum foils and/or combinations hereof.

The term “delivery table” should in this context be understood as a table or platform, where the table or platform serves to receive the cellulose fiber based material after it has been cut into sheets. In a preferred embodiment, the delivery section includes a delivery table.

Through the use of a stable machine, it is possible to transfer individual sheets from the delivery station to a delivery area suitable for receiving a platform for collecting said individual sheets.

In accordance with a third aspect of the present invention, a stacking machine is provided for handling a single sheet or individual sheets, said stacking machine comprising a frame assembly, a delivery station, a transfer station for transferring sheets individually from said delivery station to a receiving area,
said frame assembly including support columns for supporting said delivery station, and said transfer station,
said delivery station having a delivery table defining a first horizontal plane,
said transfer station including a handling arm,
said delivery table serving to receive and present said sheets individually,
said handling arm being movable from a first position above said delivery table to a second position above said receiving area, said handling arm including holding members for contacting said sheets individually and transferring said sheets individually from said delivery table to said receiving area for releasing said sheets individually at said receiving area.

Through the use of a stacking machine, it is possible to move said sheets individually from said delivery table to the receiving area for collecting said individual sheets on e.g. a platform such as a table or a pallet.

The advantageous aspect of the present invention is that the stacking machine can be arranged in close vicinity of the delivery station in a production facility, and furthermore the transfer station can be arranged above said delivery station and a receiving area, whereby the transfer station does not occupy space on the production floor.

The handling of a single sheet would preferably occur in a working process, where the single sheet is to be positioned in between items to be stacked on a pallet, so that the sheet is used as an intermediate layer to avoid sliding or skidding of the stacked items. The single sheet would likely be used for supporting the item(s) or product(s) positioned on top of the sheet and would also be able to protect the item(s) from becoming dirty. The handling of several individual sheets would refer to a situation, where a number of individual sheets are to be stacked on top of each other into a pile on a pallet.

It is possible to position the individual sheets on a pallet, allowing the pallet to be moved to the receiving area by a conveying mechanism such as a conveyor belt, forklift, wagon etc. A number of pallets can be conveyed to and from the receiving area allowing the individual sheets to be stacked on top of each other on the pallets. One operation mode could be to move a first pallet to the receiving area, where one or several sheets are stacked on the first pallet, and the first pallet is hereafter replaced by a second pallet allowing a continuously stacking of cellulose fiber sheets.

According to the third aspect of the invention, said handling arm being suspended by said frame assembly or alternatively being suspended by a separate frame and said handling arm resting on supporting columns at one end and being connected to said delivery station at the opposite end, allowing said transfer station to span the width of said delivery station.

Through the use of a handling arm being suspended by said frame assembly, it is possible to obtain a mechanical construction, which can be mounted in a different location in combination with the dispensing system.

According to the third aspect of the invention, said transfer station including a gantry, spanning at least partly the dimension of said delivery station perpendicular to said width and being movable along said width of said delivery station, preferably said gantry is spanning substantially half the dimension of said delivery station perpendicular to said width, more preferably said gantry is spanning at least half the dimension of said delivery station perpendicular to said width.

Through the use of a gantry, it is possible to obtain a mechanical construction, where the gantry can span several stations of the production line, and the delivery station and the receiving area can be arranged apart from each other.

The gantry is depicted to be moved along guide rods, spanning in-between supporting columns in a first end of the supporting structure, for the fixation of the gantry, to the delivery table in the opposite end of the first end of the supporting structure for the gantry. However still within the scope of this invention, it is possible that the operation of the gantry is not constrained to only move along the lengthwise direction of the delivery table, as the handling arm could be fitted with means enabling the handling arm to be moved in the transverse direction of the length of the transfer station and/or delivery station.

According to the third aspect of the invention, said transfer station comprising a substantially vertical supporting column connected to said frame assembly, said handling arm being pivotally connected to said vertical supporting column and further being displaceable in a substantially vertical direction in relation to said vertical supporting column.

Arranging the transfer station having a substantially vertical supporting column with the handling arm pivotally connected thereto and being displaceable, preferably slideable displaceable, in relation to the substantially vertical supporting column, enables the handling arm, including the holding members, to swing across the delivery table for contacting the sheets individually and transferring the sheets individually from said delivery table by swinging the handling from above the delivery table to above the receiving area for releasing the sheets individually at the receiving area. Preferably at a pallet arranged at the receiving area. Further, as the handling arm is arranged vertically slideable on the vertical supporting column, the transfer station is able to transfer the sheets from the level of the delivery table to a lower level, e.g. a surface level of a pallet placed at a floor level or to a higher level, e.g. a table having a higher surface than the delivery table. The arrangement of the vertical support column and the pivotally and vertically slideable handling arm may be electrically, hydraulic, pneumatic or manually driven.

According to the third aspect of the invention, said stacking machine comprising a receiving assembly arranged in said receiving area, said receiving assembly having a platform for collecting said individual sheets.

The receiving assembly may be constituted by a number of arrangements having an upper surface constituting a platform. Examples of such arrangements may be a table, a forklift or wagon carrying a pallet etc. The receiving assembly may even be constituted only by a pallet placed at floor level.

According to the third aspect of the invention, said holding members are constituted by vacuum lifters located at the perimeter of the handling arm, said vacuum lifters being used for transferring said sheets. Through the use of vacuum lifters, it is possible to obtain secure and stable lifting of said sheets, where the contact and release of said sheets does not leave any indentation or marking on the sheets. Alternatively, the vacuum lifters could also be other types of grabbing means or mechanism either mechanical or electrical actuated.

According to the third aspect of the invention, said receiving assembly has a linkage mechanism, preferably a scissor mechanism, enabling the platform to be moved between the first and second levels and said linkage mechanism being connected to an actuator. Through the use of a linkage mechanism, it is possible to obtain a compact mechanism and a precise movement of said receiving assembly, where the amount of force need is reduced due to the inherent gearing provided by the scissor mechanism.

According to the third aspect of the invention, said transfer station is connected to a controller for allowing operation of the transfer station in connection or communication with the delivery station and/or receiving assembly. Through the use of a controller, it is possible to obtain a synchronized operation between the different stations of the stacking machine. It is furthermore possible to allow the operation of each station independently of each other, so that the each station can be operation independently of the other stations or in dependence.

According to the third aspect of the invention, said stacking machine further comprises a sheet dispensing system for dispensing individual sheets, said sheet dispensing system comprising a frame assembly, a reel loading station, a sheet dispenser station, and said delivery station,
said reel loading station, said sheet dispenser station, and said delivery station being supported individually or collectively by said frame assembly,
said reel loading station including a supply reel of a cellulose fiber based web and a support for supporting said supply reel and allowing the dispensing of said cellulose fiber based web from said supply reel,
said sheet dispenser station including a feeding mechanism and a cutting mechanism,
said feeding mechanism serving to receive said cellulose fiber based web from said reel loading station and having a tension roller and a feeding roller,
said cutting mechanism having a reciprocating cutter assembly for cutting said cellulose fiber based web into individual sheets when moved transversally relative to said cellulose fiber based web from a first position to a second position at opposite sides of said cellulose fiber based web and being prevented from cutting when moved in the opposite direction from said second position to said first position,
said delivery station including a delivery table connected to said sheet dispenser station for receiving said individual dispensed sheets, and
said reel loading station or said sheet dispenser station or delivery station further comprising a smoothing mechanism having a first guide roller and a second guide roller, said first and second guide rollers being adjustable in relation to one another for altering the smoothing angle dependent of the diameter of said supply reel in order to compensate for the curvature of said cellulose fiber based web and provide non-curved individual sheets.

According to a fourth aspect of the invention, the above objects and advantages obtained by:

A method of stacking individual sheets by means of a stacking machine for handling individual sheets, said stacking machine comprising a frame assembly, a delivery station, a transfer station for transferring sheets individually from said delivery station to a receiving area, comprising the steps of:
providing said frame assembly including support columns for supporting said delivery station, said transfer station,
providing said delivery station having a delivery table defining a first horizontal plane,
providing said transfer station including a handling arm,
providing a receiving assembly having a platform for collecting said individual sheets,
delivering and presenting said sheets individually on said delivery table,
moving said handling arm from a first position above delivery table to a second position above said receiving assembly,
activating said holding members for contacting said sheets individually,
transferring said sheets individually from said delivery table to said receiving assembly,
releasing said sheets individually at said receiving assembly,
moving said platform vertically from a first level to a second level, said first level being substantially in the same horizontal plane as said first horizontal plane of said delivery table, and said second plane being located parallel with and below said first horizontal plane for allowing said sheets to be stacked on top of the one another.

According to the fourth aspect of the invention, said method comprises the steps of:
delivering said sheets continuously on said delivery table
transferring said sheets individually from said delivery table to said receiving assembly synchronized with said sheets being delivered individually to said delivery table.

According to the fourth aspect of the invention, said method comprises the steps of:
delivering said sheets intermittently on said delivery table
detecting the presence of said sheets
transferring said sheets to said receiving assembly by stopping the delivery of said sheets during the step of transferring said sheet to said receiving assembly.

In accordance with the fourth aspect of the present invention, it is possible to obtain a reliable operation, where sheets can be moved from one station to another station, and where the stations can be operated in a synchronized manner. Furthermore, the transfer station can be arranged above said delivery station and said receiving assembly, whereby the operation of the transfer station does not occupy space on the production floor.

The third and fourth aspect of the present invention may advantageously be combined with the first and second aspect, respectively, allowing individual handling of sheets being delivered and presented on a delivery station.

### DETAILED DESCRIPTION

The invention will now be explained in detail with reference to the schematic drawings in which:

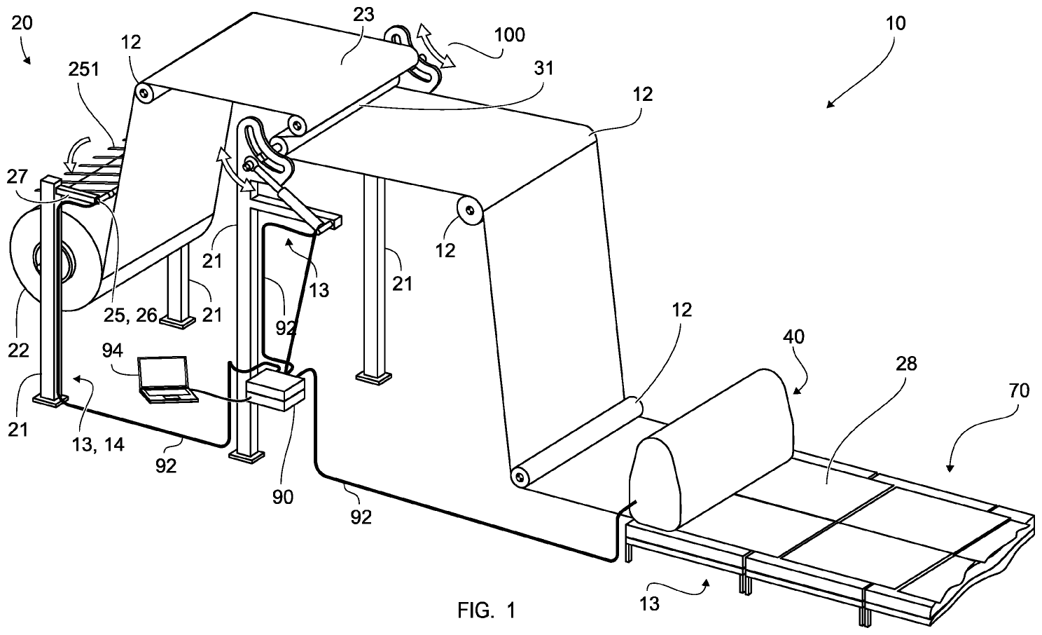

FIG. 1 is an overall schematic and perspective view of an embodiment of the sheet dispensing system for dispensing and supplying individual sheets of paper or cardboard.

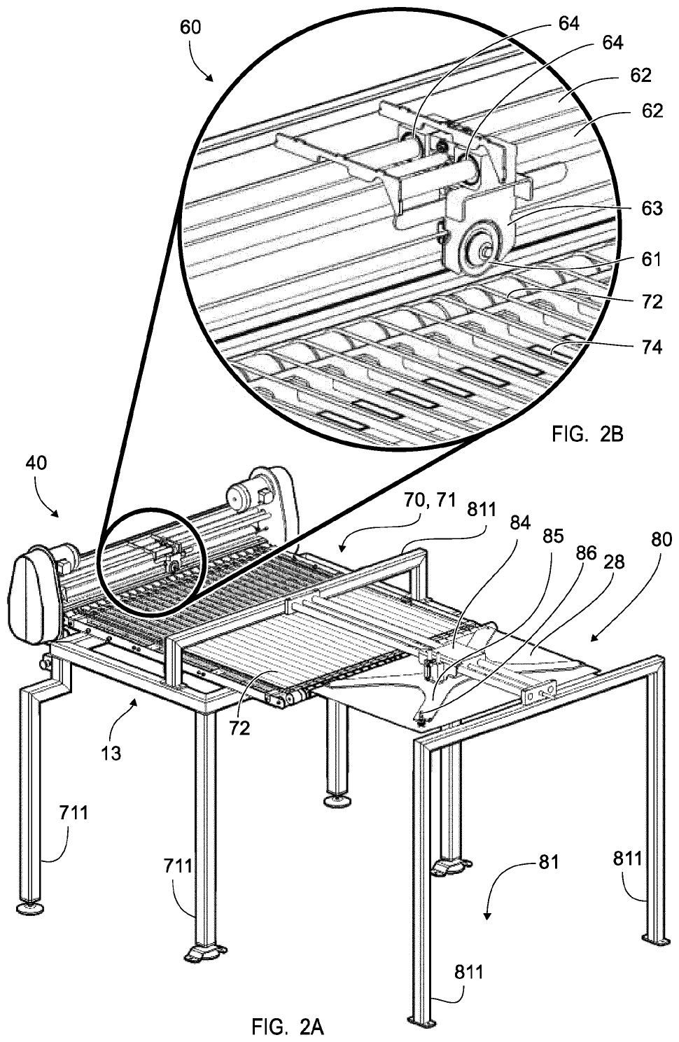

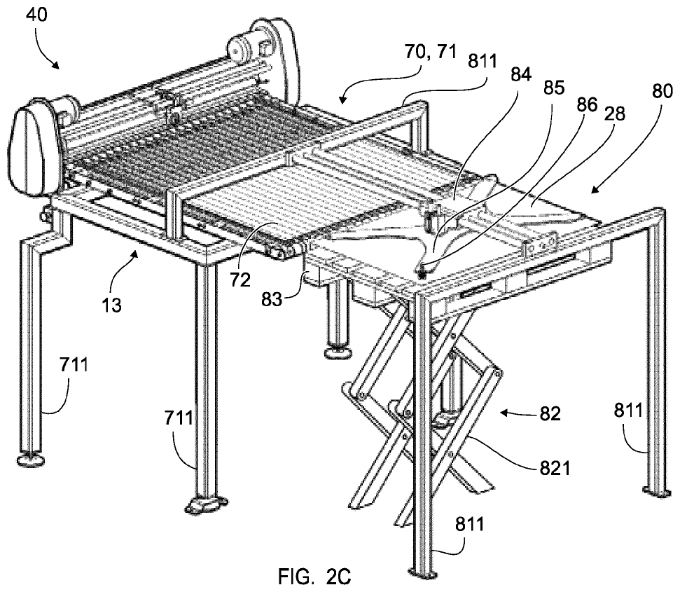

FIG. 2A is a perspective view of an embodiment of the sheet dispenser station with the cutting mechanism.

FIG. 2B is a close up view of FIG. 2A of the cutting mechanism of an embodiment of the sheet dispenser station.

FIG. 2C is a perspective view of an embodiment of the sheet dispenser station with the cutting mechanism according to a first aspect of the present invention.

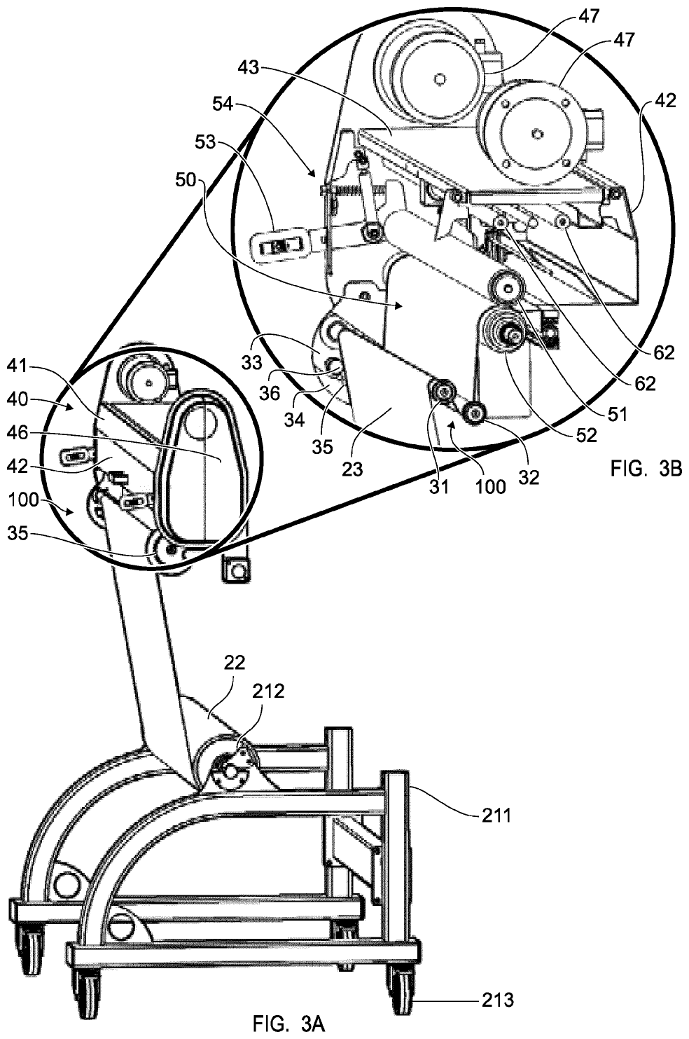

FIG. 3A is a perspective view of an embodiment of the reel loading station and the sheet dispenser station with the smoothing mechanism and the feeding mechanism for dispensing individual sheets of paper or cardboard.

FIG. 3B is a close up view of FIG. 3A of the smoothing mechanism and the feeding mechanism of a first presently preferred embodiment of the sheet dispenser station.

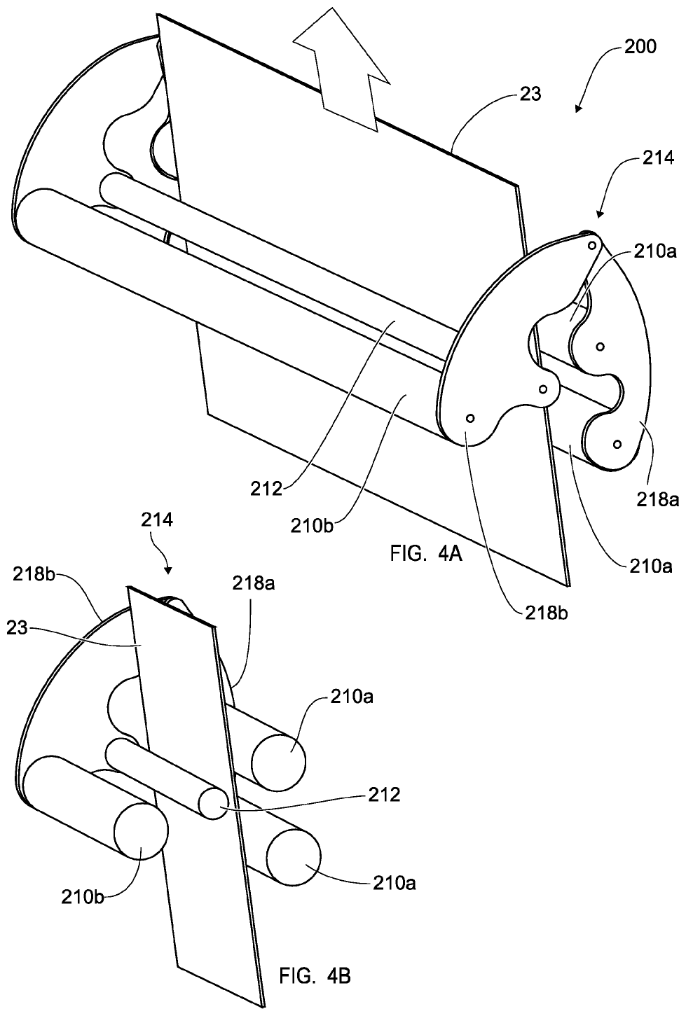

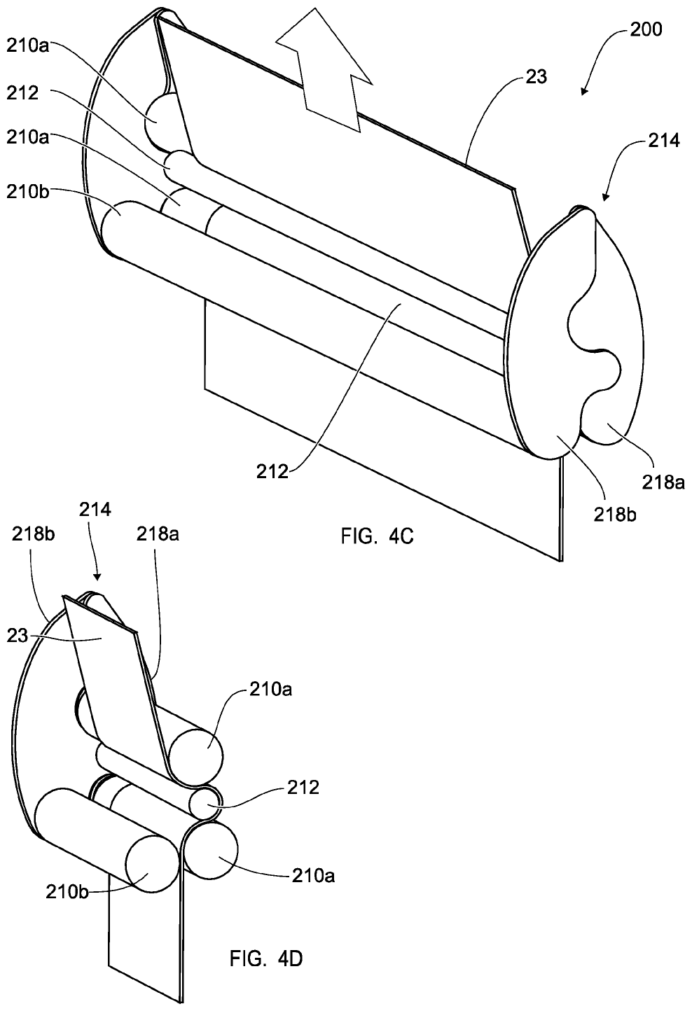

FIG. 4A-4D shows perspective view of the smoothing mechanism.

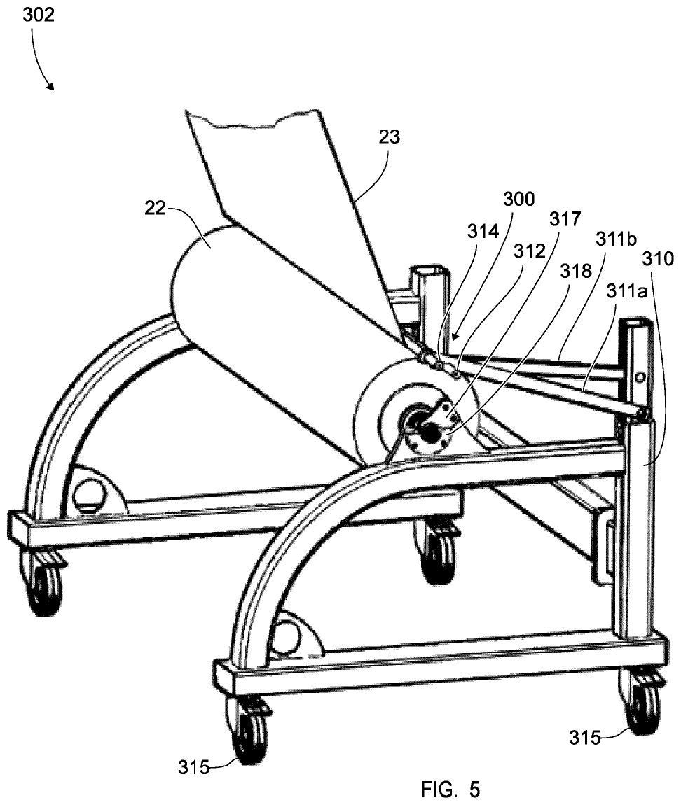

FIG. 5 is a perspective view of the reel loading station with a third preferred embodiment of the smoothing mechanism connected to the reel loading station according to a third aspect of the present invention.

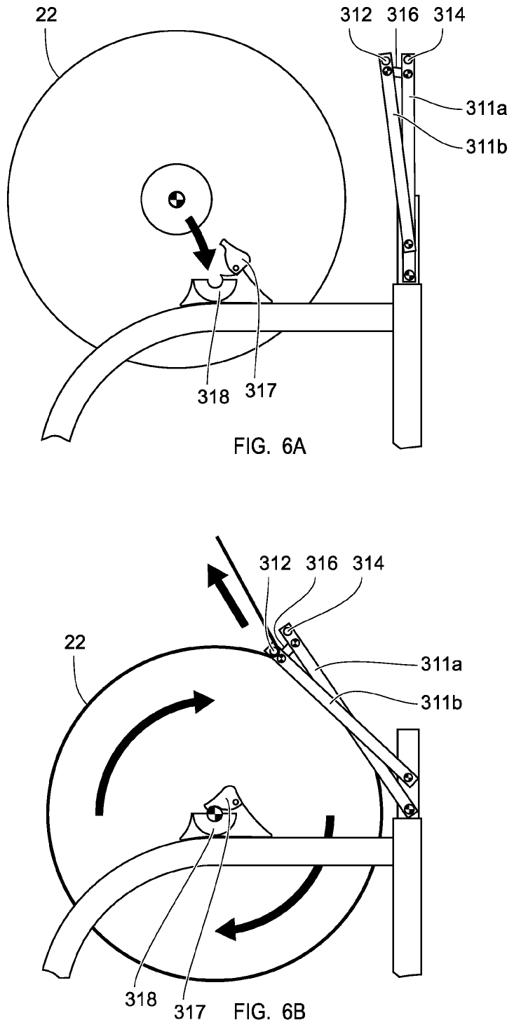

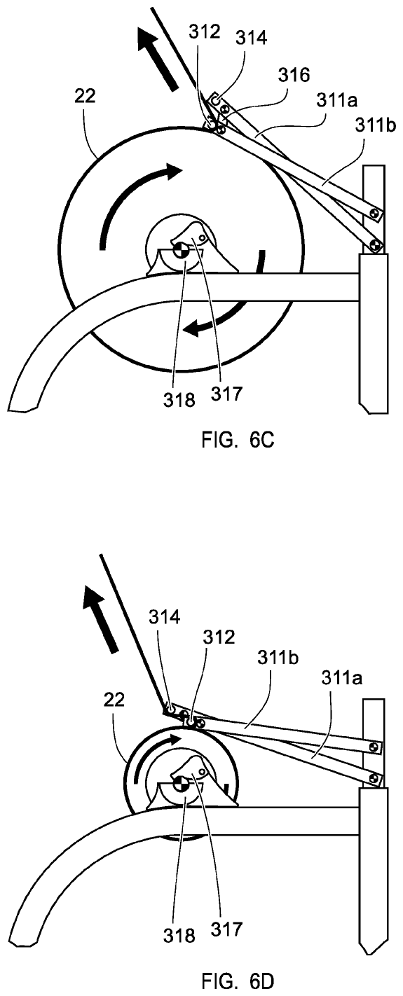

FIG. 6A shows the loading of a supply reel in the reel loading station with the smoothing mechanism according to a third aspect of the present invention.

FIG. 6B-6D shows the unrolling of material from the supply reel in the reel loading station with a third preferred embodiment of the smoothing mechanism connected to the reel loading station according to a third aspect of the present invention.

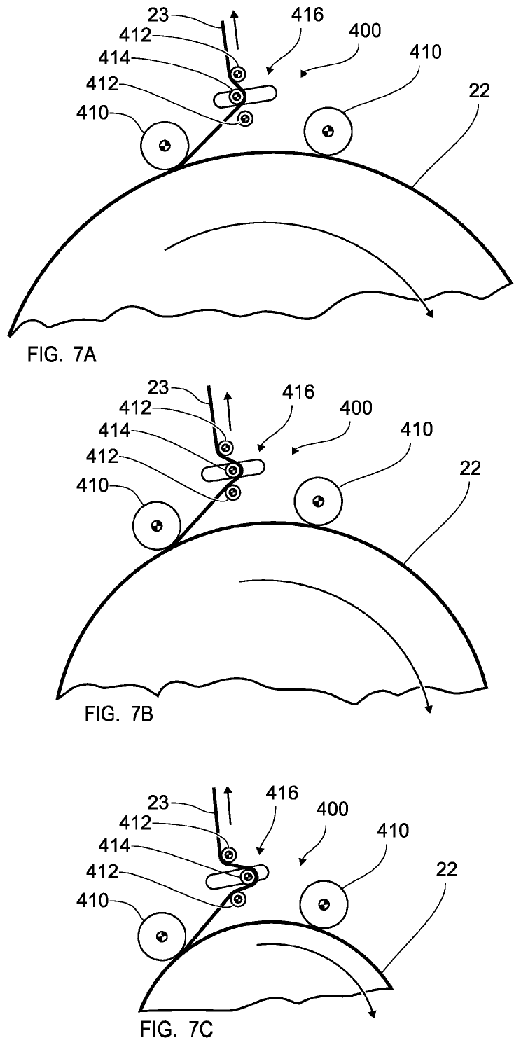

FIG. 7A-7C shows the unrolling of material from the supply reel in the reel loading station with a fourth preferred embodiment of the smoothing mechanism according to a fourth aspect of the present invention.

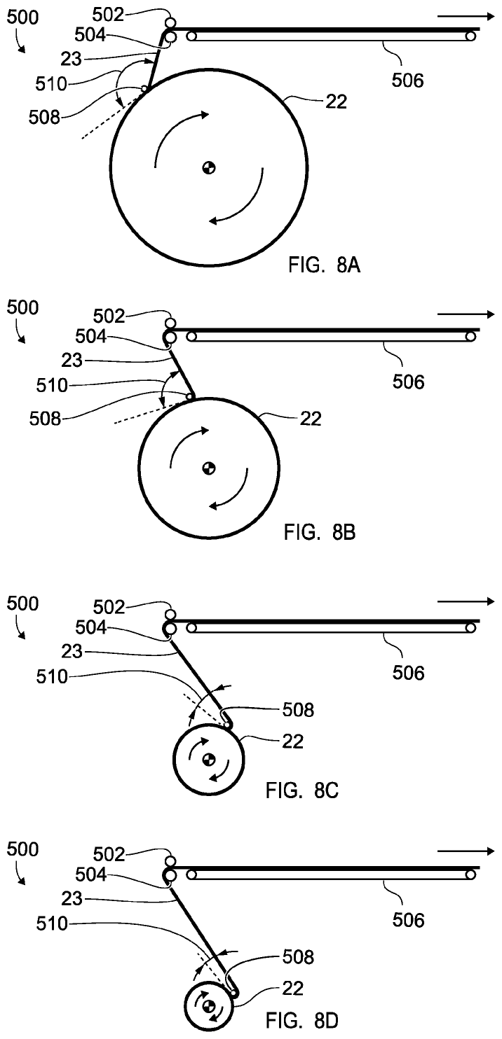

FIG. 8A-8D shows the unrolling of material from the supply reel in the reel loading station according to a fifth aspect of the present invention.

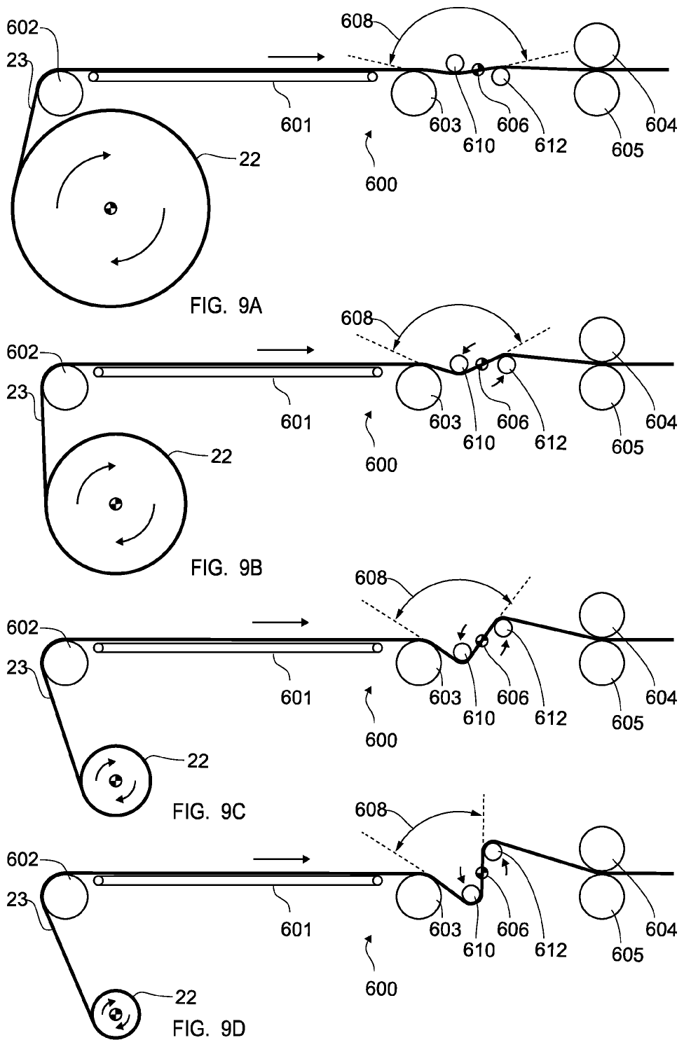

FIG. 9A-9D shows the unrolling of material from the supply reel in the reel loading station according to a sixth aspect of the present invention.

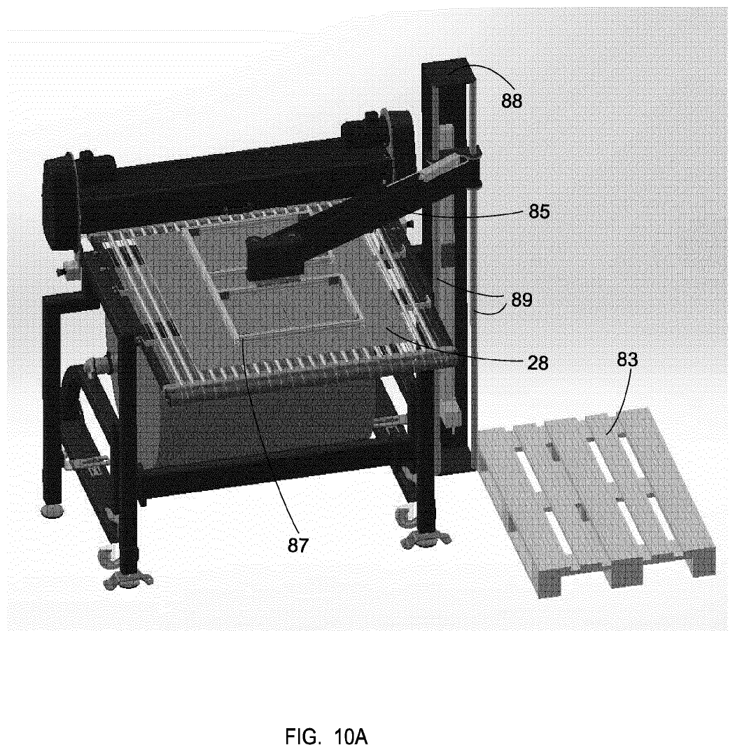

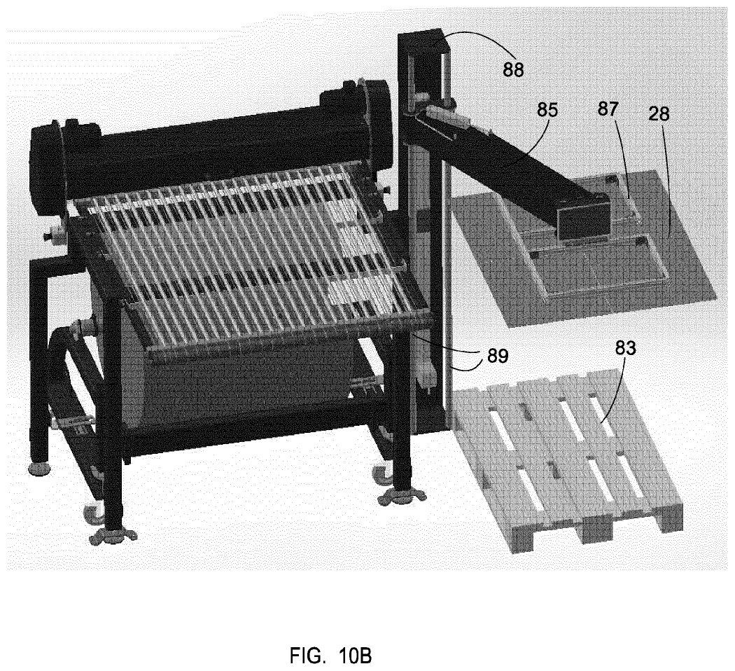

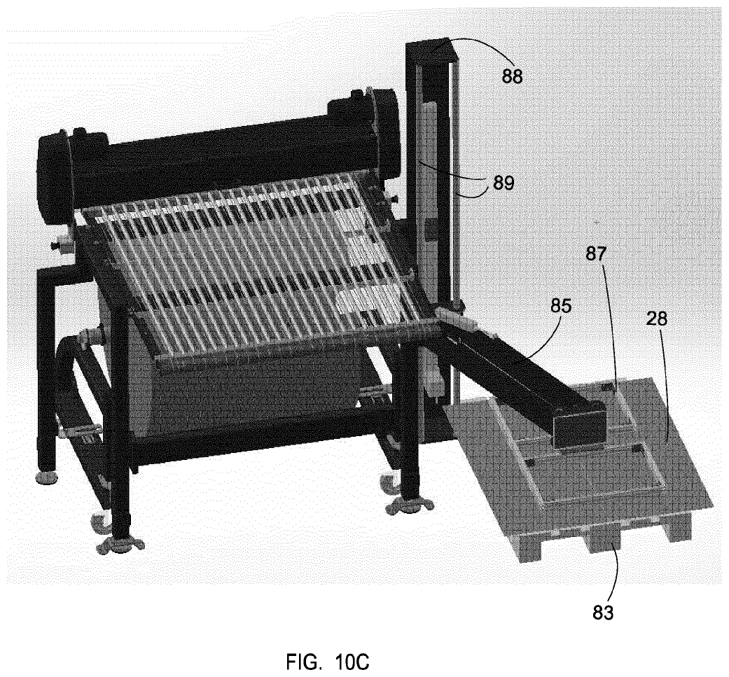

FIG. 10A-10C shows a perspective of the stacking machine having a vertical support column.

In FIG. 1, a first and presently preferred embodiment of a system for providing sheets of paper or cardboard (cellulose fiber based material) is shown designated the reference numeral 10 in its entirety. The system 10 comprises a reel loading station 20, a sheet dispenser station 40, a controller 90 and a delivery station 70. The cellulose fiber based material in the form of paper or cardboard is unrolled from the supply reel 22 and introduced to the sheet dispenser station 40. The sheet dispenser station 40 (hereafter referred to as the sheet dispenser) comprises a feeding mechanism 50 (not shown in FIG. 1) enabling the supply of paper or cardboard to be drawn through the sheet dispenser station 40, where the paper or cardboard is cut into the sheet 28, which will be dispensed onto the delivery table 71. The individual sheets 28 shown in FIG. 1 are cut both in the transverse direction and in the longitudinal direction. The paper or cardboard would be referred to as cellulose-based material.

From FIG. 1 it can be seen, that the cellulose fiber based material would travel over a number of roller 12, which would allow the cellulose fiber based material to be transferred between the different unit of the sheet dispensing system. Through the use of a number of roller 12, the different unit would not have to be located in close vicinity of each other, which would be advantageous as the sheet dispensing system could be fitted into different production facilities, where the area of the ground floor could be utilized for other purpose.

The reel loading station 20 comprises a supporting frame 14 for the supply reel 22 of paper or cardboard. The supporting frame 14 is shown in an embodiment, where the supporting frame 14 would consist of four supporting columns 21, where the supply reel 22 has an axle penetrating the centre of the supply reel and where the weight of the supply reel is supporting the two supporting columns. The supply is supported in a manner that allows the supply reel to rotate freely around the centre axle. The reel loading station is intended to be operated in a stepwise manner, allowing continuous feeding of the cellulose fiber based web to the sheet dispenser station, where the continuous feeding is stopped when the cutting of the cellulose fiber based web is performed.

The cutting could also be performed without stopping the dispensing of the cellulose fiber based web from the sheet dispensing station, this would however require that the cutting mechanism is provided on a movable unit. This provides an “on the fly” operation mode.

The reciprocating cutter is shown as a mechanical cutter, more precisely a mechanical roller knife. Instead of using a reciprocating cutter, e.g. a mechanical knife, it would also be possible to provide a laser cutter and enabling a continuous cutting of the cellulose fiber material, which in this case would be supplied continuously during the cutting process.

As can be seen in FIG. 1, the reel loading station 20 further comprises a supporting roller 25, which is suspended from the supporting frame 14, the supporting roller 25 is preferably pivotally suspended from the supporting frame 14 by means of a two support arms 27, whereby the supporting rollers 25 are able to arrest on the circumference of the supply reel 22. The supporting roller 25 comprises a reel sensor 26, which is able to send data of the position of the supporting roller 25 to a controller 90 interconnected with a computer 94. As depicted in FIG. 1 the supporting rollers could further be provided with fingers 251. The reel sensor can be any type of sensor, which can be used for the purpose of generating an electrical signal, which can be used to indicate or determine a position, e.g. a potentiometer.

The sheet dispensing system 10 comprises a controller 90, which is interconnected with the reel loading station via cables 92 and where the controller 90 comprises an input channel and an out channel. The controller 90 receives signals from the reel sensor 26 connected to said reel loading station 20 and from the collected data from the reel sensor 26, the collected data is used to determine the diameter of the supply reel 22.

The collected data from the reel sensor 26 is used to adjust the position of the guide roller (not shown) of the smoothing mechanism 100, whereby the smoothing mechanism is adjusted in order to ensure the sufficient amount of smoothing for the paper based material.

As shown in FIG. 1, the smoothing mechanism 100 is a dependent unit of the sheet dispensing system, which can be connected to either the sheet dispenser station, the delivery table or the reel loading station, which is reflected in the figure.

FIG. 2A shows the sheet dispenser station 40 including the cutting mechanism 60 and the feeding mechanism 50 (not shown) in a presently preferred embodiment of a system for providing layer of paper or cardboard according to a first aspect of the present invention. The feeding mechanism 50 and the cutting mechanism 60 will be explained in more details in relation to FIG. 3B. The sheet dispenser station includes feeding means for drawing in the cellulose fiber based material from the supply reel 22. The feeding mechanism 50 comprises two rollers, which interact in mutual operation, allowing a free end of the cellulose fiber based material to be placed between the mutually interacting rollers, whereby the cellulose fiber based material can be drawn into the sheet dispenser station 40.

The sheet dispenser station 40 is connected to the delivery station 70, which comprises a delivery table 71 onto which the cut sheets are delivered and a transfer station 80 located at the end of the delivery table 71, so that the sheets 28 can be transferred from the delivery table 71 on the pallet 83. The delivery table 71 arrests on an underframe 710 with supporting columns more precisely four supporting columns 711, which can be adjusted to level out the delivery table 71 on the ground floor of the production facilities.

In FIG. 2A, a stacking machine for handling individual sheets 28 is shown, said stacking machine comprising a frame assembly 13, a delivery station 70, and a transfer station 80 for transferring sheets 28 individually from the delivery station 70 to a receiving area 81. The frame assembly 13 includes support columns 711, 811 for supporting said delivery station 70 and said transfer station 80. The delivery station 70 has a delivery table 71 defining a first horizontal plane. The handling arm 85 is used for transferring the sheet 28 from the delivery table 71 onto the platform such as a pallet (not shown), where the sheets can be stacked, and the delivery table 71 serves to receive and present the sheets 28 individually. The handling arm 85 is movable from a first position above the delivery table 71 to a second position above the receiving area 81 and the handling arm 85 includes holding members 86 for contacting the sheets 28 individually and transferring the sheets 28 individually from the delivery table 71 to a position above the receiving area 81 and releasing the sheets individually at the receiving area 81.

The handling arm 85 is suspended by the frame assembly 13, and the handling arm 85 is resting on supporting columns 811 at one end, and being connected to the delivery station in the opposite end, allowing the transfer station 80 to span the width of the delivery station 70. The handling arm 85 is provided with holding members 86 being constituted by vacuum lifters, located at the perimeter of the handling arm, and the vacuum lifters being used for transferring the sheets. The vacuum lifters may be connected to a pneumatic system (not shown).

The transfer station 80 includes a gantry 84 which in the illustrated embodiment, spans substantially half the dimension of the delivery station 70 perpendicular to the width thereof, and being movable along the delivery station 70 and above the receiving area 81.

The gantry 84 spans the width of the transfer station 80 and substantially half of the length of the delivery table. The gantry 84 can also be connected to the controller 90, which would allow for operation of the gantry 84 in connection or communication with the sheet dispenser station, delivery table and the gantry 84.

The controller can be operated for the purpose of synchronizing the operation of the different stations of the dispensing system including the stacking machine.

The controller can be programmed to deliver the sheets 28 continuously on the delivery table 71 in order to transfer the sheets 28 individually from the delivery table 71 to the a position above the receiving area 81 before the next sheet 28 being delivered to the delivery table 71.

The controller can be programmed to deliver the sheets 28 intermittently on the delivery table 71, detecting the presence of the sheets 28 and transferring the sheets 28 from the delivery table 71 to a position above the receiving area 81 and stopping the delivering of the sheets 28 during the step of transferring the sheets 28 to a position above the receiving area.

In FIG. 2A, the delivery table 71 includes one or several conveying means 72, which will ensure that the individual sheets 28 of the cellulose fiber based material are advanced from the cutting mechanism 60 in the longitudinal direction of the delivery table. The conveying means 72 could be in the form of conveyer belts, which will move the individual sheets on the delivery table 71 after the cellulose fiber based material has been cut by the cutting mechanism 60. The conveyer belts will stretch out the individual sheets on the delivery table 71 after the cellulose fiber based material (web). The delivery station 71 includes a sensor 74, and the senor 74 is used for detecting the presence and location of the sheets. A number of sensors can be arranged on the delivery table in between the conveyer belts. The sensor(s) could also be in combination with the controller for adjusting the guide rollers of the smoothing mechanism.

In FIG. 2B can be seen that the cutting mechanism 60 of the sheet dispenser station 40 includes a reciprocating cutter, preferably a mechanical cutting knife 61, which serves to cut the cellulose fiber based web from the supply reel 22 into pieces of sheets having a convenient size when they are fed to the delivery table 71. The cutting knife 61 is oriented transversely of the longitudinal direction of the delivery table 71 for cutting off the part of the cellulose fiber based web 23 having its end drawn forth a suitable length. The cutting knife 61 is in the shown embodiment a mechanical roller knife mounted on a guided sledge 63, on which the knife 61 can freely rotate around it centre. The sledge 63 is able to move in the transverse direction of the longitudinal direction of the delivery table 71 and the sledge 63 is guided by two guide rods 62, where the bushings 64 are in interposition between the two outer guide rods 62 and the sledge 63. The cutting knife 61 can be moved pulling the cable 65 or by other similar means to drag the roller knife back and forth.

FIG. 2C illustrates a similar embodiment as shown in FIG. 2A. In FIG. 2C, the receiving assembly 82 is illustrated as a linkage mechanism 821, preferably a scissor mechanism 821, enabling a platform to be moved between first and second levels and the linkage mechanism being connected to an actuator (not shown).

The platform 83 (illustrated as a pallet) may be moved vertically from a first level to a second level and the first level is substantially in the same horizontal plane as the first horizontal plane of the delivery table 71, and the second plane is located in parallel with and below the first horizontal plane for allowing the sheets 28 to be stacked on top of the one another.

FIG. 3A shows a preferred embodiment of the reel loading station 20 and the sheet dispenser station 40 with the smoothing mechanism 100 for dispensing individual sheets of paper based material. The reel loading station 20 is where the cellulose fiber based web 23 is fed to the sheet dispenser station 40. The reel loading station 20 includes an underframe 211 for supporting the supply reel 22, which is rotatably suspended on the underframe 211 having four castor wheels 213. The underframe 211 is equipped with bushings 212, which support the through going axle of the supply reel 22. The through going axle of the supply reel 22 is furthermore locked relative to the underframe by a stop ring (not shown).

FIG. 3B shows a close up view of the smoothing mechanism 100 and the feeding mechanism 50 of the first presently preferred embodiment of the sheet dispenser station according to a first aspect of the present invention, where the feeding mechanism 50 comprises interspaced rollers (51,52), which are synchronously driven by using a belt. The free end of the cellulose fiber based web 23 is fed to the cutting station 60, where the cutting knife 61 cuts the cellulose fiber based web into individual sheets 28 (intermediate layer).

The sheet dispenser station 40 comprises a housing 41 having two housing covers 42, a top wall 43, bottom wall 44, two side walls 45 and side wall covers 46. The two housing covers 42 are both located in the longitudinal direction of the dispensing direction of the cellulose fiber based web 23 and the housing covers 42 are hinged to the top wall 43 of the dispenser housing 41, which will provide accesses to the interior of the sheet dispenser station for the operator.

In FIG. 3B, the feeding mechanism 50 comprises two interspaced rollers (51,52), where the first roller is a tension roller 51, which can be moved by operating the handle 53, whereby movement of the tension roller 51 is obtained. The tension mechanism of the feeding mechanism 50 is achieved by a movable tension roller 51 and a feeding roller 52, which are arranged and connected to the side walls 45 of the sheet dispenser station housing 41. The tension roller 51 is connected in each end to a linkage mechanism 54, where the linkage mechanism 54 itself is connected to the side walls 45 of the sheet dispenser station housing 41. Each linkage mechanism 54 penetrates an opening in the housing covers 42 allowing the operator to grab the tensioning handle 53 on each of the linkage mechanisms 54. By operation of the tensioning handle 53, the tension roller 51 can be moved or be disconnected from engagement with the feeding roller 52, depending on whether or not the free end of the cellulose fiber based web is to be inserted into the feeding mechanism 50.

The tension roller 51 and the feeding roller 52 constitute the main elements of the feeding mechanism. The feeding roller 52 is connected by means of a belt to a motor 47 in each end, and the elements are covered by side wall covers 46. The motor 47 is located in the upper part of the sheet dispenser station housing 41 and will, when activated, rotate the feeding roller 52, which in cooperation with the tension roller 51 will guide and dispense the cellulose fiber based web through the sheet dispenser station 40.

An emergency stop 25 is provided on the sheet dispenser station housing 41. The sheet dispenser station 40 may also include means to apply a coating to the cellulose-based material.

The smoothing mechanism 100 in FIG. 3A and FIG. 3B is shown according to a first aspect of the present invention, where the smoothing mechanism 100 is connected to the side wall 45 of the sheet dispenser station housing 41. The smoothing mechanism 100 comprises a guide plate 33 and two guide rollers, which would be referred to as a first guide roller 31 and a second guide roller 32. The first guide roller 31 and second guide roller 32 are both mounted on a guide plate 33, which is pivotally connected to a mounting plate 34 connected with the side wall 45 of the sheet dispenser station housing 41.

The mounting plate 34 is provided with an arc portion having a number of slots 35 extending the width of the mounting plate 34, where the slots 35 are arranged near the circumference of the arc shape of the mounting plate 34. A lever 36 with biasing means is arranged perpendicular on the guide plate 33, where the lever 36 is provided with a pin being substantially longer than the width of the guide plate 33. This will allow the lever 36 to provide an interlocking of the guide plate 33 relative to the mounting plate 34.

The guide plate 33 is pivotally connected to the mounting plate 34, so that the pivot axis of the mounting plate 34 is coincident with the longitudinal axle of the second guide roller 32. In this way, the distance between the longitudinal axis of the feeding roller 52 and the longitudinal axis of the second guide roller 32 is maintained during the advancing process of the cellulose fiber based web (intermediate sheet layer).

In FIG. 3A and FIG. 3B, the smoothing mechanism 100 is shown in a position, where the smoothing mechanism is raised to the highest possible position in relation to the sheet dispenser station. In the highest position, the lever 36 is inserted in the slot at the highest position on the circumference of the arc portion of the mounting plate 34, this point would be located at the longest distance from the ground floor.

The amount of smoothing of the cellulose fiber based web is determined by the number of slots provided in the sheet dispenser station 40, more precisely by the number of slots provided in the mounting plate 34 of the sheet dispenser station, which is decisive for the position of the first guide roller 31, and thereby the angular position of the first guide roller 31 in relation to the second guide roller 32 of the smoothing mechanism 100.

When the smoothing mechanism 100 is fixed in the highest possible position, then the contact area between the paper web and the guide rollers 31, 32 is at its maximum level, whereas when the smoothing mechanism is lowered by a pivoting movement around the axis of the second guide roller, then the contact surface between the cellulose fiber based web and the guide rollers 31, 32 is at its minimum level.

The number of slots provided in the mounting plate 34 of the sheet dispenser station, allows for at a stepwise adjustment for the smoothing mechanism. Another embodiment of the smoothing mechanism 100 is shown in FIG. 1, where the adjustment can be performed in a continuous manner, through the use of one actuator connected to the frame of the sheet dispensing system, and where the adjustment is achieved in cooperation with a curved recess in a guidance plate connected to the frame of the sheet dispensing system.

The smoothing angle is the angle, which is established by the position of the guide rollers, e.g. in FIG. 3A. The smoothing angle is opposite the convex arc or the tangent line for the guide roller. The smaller the smoothing angle is, the larger the contact surface would be, hereby the contact surface of the cellulose fiber based web with the guide roller of the smoothing mechanism would be larger.

FIG. 4A-4B shows the smoothing mechanism 200 according to a second aspect of the present invention, where the smoothing mechanism 200 can be positioned below the cutting section of the sheet dispenser station (not shown). The smoothing mechanism 200 comprises four guide rollers 210a, 210b, 212 having each guide rollers connected in the end to main frame 214. The main frame 214 comprises two frame plates 218a, 218b, which are interconnected in one end allowing the two frame plates 218a, 218b to be pivotable around a common pivot axis. The cellulose fiber based web 23 is fed through the smoothing mechanism 200 and dependent on the amount upon the thickness and density of the cellulose fiber based web, the frame plates 218a, 218b will be clamped together, whereby the secondary guide roller 212 on the second frame plates 218b will be interposed between the two primary guide roller 210a on the first frame plate 218a.

FIG. 4C-4D shows the smoothing mechanism 200 in the position, where the primary guide roller 210a on the first frame plate 218a and the secondary guide roller 212b on the second frame plates 218b are fully engaged in order to achieved the maximum compensation for an unwanted curvature of the cellulose fiber based web 23. The amount of smoothing can be adjusted by movement of the secondary guide roller 212 on the second frame plates 218b relative to the two primary guide rollers 210a on the first frame plate 218a.

In FIG. 5, the smoothing mechanism 300 reel loading station 302 is shown according to a third aspect of the present invention, where the smoothing mechanism 300 is connected to the reel loading station 302. The connection of the smoothing mechanism 300 is obtained through the use of linkage rods 311, where a pair of linkage rods 311 are used for suspending the first guide roller 312 and the second guide roller 314 in each end. Each linkage mechanism comprising two linkage rods 311 are interconnected by a linkage lever 316 and the linkage rods 311 are in one end connected to the underframe 310. The first linked rod 311a is connected to the first guide roller 312 in the end opposite the end connected to the underframe 310. The second linked rod 311b is connected to the second guide roller 314 in the end opposite the end connected to the underframe 310. The first guide rollers 312 will arrest on the circumference of the supply reel 22.

FIG. 5-6D shows the smoothing mechanism 300 according to a third aspect of the present invention. A supply reel 22 is loaded in the reel loading station 302 and the supply reel 22 is supported by bushing 318 located on the underframe 310 for supporting the supply reel 22, which is rotatable suspended on the underframe 310 having four castor wheels 315. The underframe 310 is equipped with bushings 318, which support the through going axle of the supply reel 22 and the axle of the through going axle of the supply reel 22 is furthermore locked relative to the underframe by a locking element 317.

FIG. 6B-6D shows the sequence of unrolling the cellulose fiber based web 23 from the supply reel 22 in the reel loading station 302. The smoothing mechanism 300 works in dependency of the diameter of the supply reel 22. The first guide roller 312 and the second guide roller 314 will during unrolling of the cellulose fiber based web 23 from the supply reel 22 be adjusted in relation to one another, which would alter the smoothing angle dependent of the diameter of said supply reel in order to compensate for the curvature of said individual sheets and provide non-curved individual sheets.

When comparing FIG. 6B, which shows the fully loaded supply reel 22 and FIG. 6D, which shows a supply reel after the majority of the cellulose fiber based web 23 has been rolled off the supply reel 22, it is furthermore possible to see that the second guide roller 314 has moved from a first position (initial) behind the first guide roller 312 in the vertical plane to a second position being in front of the first guide roller 312 in FIG. 6D.

FIG. 7A-7C shows a principle drawing of a fourth preferred embodiment of the smoothing mechanism 400 according to a fourth aspect of the present invention. The reel loading station is connected to the reel loading station, however not shown in FIG. 7A-7C for the sake of simplicity. The smoothing mechanism 400 comprises a supporting frame, supporting rollers 410, a pair of first guide rollers 412 and one second guide roller 414, the pair of first guide rollers 412 being connected to the supporting frame, where the first guide rollers 412 are positioned with a distance in between one another. The supporting frame comprises a recess 416 extending between the first guide rollers 412 in a direction being perpendicular to the distance between the two first guide rollers 412. A second guide roller 112 is provided and positioned in the recess 316 of the supporting frame, and the second guide roller 414 is moved between a first position to a second position.

FIG. 7A shows the second guide roller 414 in the first position, where the second guide roller 414 applies a minimum of force to the cellulose fiber based web 23. FIG. 7C shows the second guide roller 414 in the first position, where the second guide roller 414 applies a maximum force to the cellulose fiber based web 23.

By increasing the engagement of the second guide roller 414 in relation to the two first guide rollers it is possible to alter the smoothing angle in dependency of the diameter of said supply reel 22. The smoothing mechanism 400 is connected to a frame by using a linkage mechanism similarly to mechanism shown in FIG. 6A-6D. By using two linkage rods, it is possible to suspend the smoothing mechanism enabling a motion pattern as shown in the FIG. 7A-7C. The linkage mechanism could be implemented by having a first linkage rod connected to the first guide roller 412 and a second linkage rod connected to the second guide roller 414. The first and second linkage rod would be connected to the frame assembly.

FIG. 8A-8D shows the unrolling of cellulose fiber based web 23 from the reel in the reel loading station according to a fifth aspect of the present invention. The smoothing mechanism 500 works in dependency of the diameter of the supply reel 22. The cellulose fiber based web 23 will be unrolled and drawn by feeding mechanism onto the delivery table 506 and the feeding mechanism comprises a first roller 502 and a second roller 504. The cutting mechanism is not shown in FIG. 8A-8D. The smoothing comprises a guide roller 508, which will be moved along the circumference of the supply reel 22 during unrolling of the cellulose fiber based web 23 from the supply reel 22 and the motion of the guide roller 508 will alter the smoothing angle 510 in dependency of the diameter of said supply reel. The guide roller 508 is moved from a first position (initial) shown in FIG. 8A to a second position shown in FIG. 8D. The first position being behind the rotation centre of the supply reel 22 (the left side of the rotation centre) and a second position being in front of rotation centre of the supply reel 22 (the right side of the rotation centre). The smoothing angle 510 is adjusted by moving the guide roller 508 along the circumference of the supply reel 22 and by changing the smoothing angle 510 it is possible to compensate for the curvature of the cellulose fiber based web 23 and provide non-curved individual sheets.

FIG. 9A-9D shows the unrolling of the cellulose fiber based web 23 from the reel in the reel loading station according to a sixth aspect of the present invention. The smoothing mechanism 600 works in dependency of the diameter of the supply reel 22. The smoothing mechanism 600 comprises a first guide roller 610 and a second guide roller 612 being adjustable in relation to one another. The cellulose fiber based web 23 will be unrolled and drawn by a feeding mechanism onto the delivery table 601 and the feeding mechanism comprises a first feeding roller 604 and second feeding roller 605. The cutting mechanism is not shown in FIG. 9A-9D. The first guide roller 610 and the second guide roller 612 is connected to a frame facilitating that the first guide roller 610 and the second guide roller 612 can rotate around a common axis 606 from a first position (initial) shown in FIG. 9A to a second position shown in FIG. 9D. In a first position, the smoothing angle is substantially 180 degrees and the gravity centre of the first guide roller 610 and second guide roller 612 defines a plane being substantial parallel with the horizontal plane of the delivery table 601. The smoothing angle 608 is adjusted by rotating the guide rollers 610, 612 around the common axis 606 and by changing the smoothing angle 608 it is possible to compensate for the curvature of the cellulose fiber based web 23 and provide non-curved individual sheets.

The solution shown in the FIG. 9A-9D provides and allows for a continuous and stepless operation of the sheet dispenser system. Besides being able to compensate for the curvature of the cellulose fiber based web 23 fed from the supply station. It is furthermore possible to have a number of sensors arranged in the delivery table 601, where the sensors are able to detect the curvature of the cellulose fiber based web 23 for allowing an “on the fly” operation mode, that provides for compensation of the curvature at a specific location.

In this way it is possible to provide a second compensation for the individual sheets, if the smoothing of the cellulose fiber based web 23 was not sufficient to straighten the sheets after being dispensed from the sheet dispenser station.

The compensation can be performed independently of the smoothing mechanism or in cooperation with the sheet dispenser station and/or the supply station. The smoothing mechanism shown in FIG. 9A-9D could also be combined with the sheet dispenser station, where the smoothing mechanism shown in FIG. 1-3b is removed and the only smoothing is performed by the smoothing mechanism shown in FIG. 9A-9D.

FIG. 9A shows a positioning of the guide rollers for obtaining a large smoothing angle (substantially 180 degree) and the compensation of the cellulose fiber based web 23 is almost insignificant. FIG. 9D shows a position of the guide rollers, where the smoothing angle is relatively small (substantially 30 degree) and the compensation for the curvature of the cellulose fiber based web 23 almost reaches its maximum.

FIG. 10A-10C shows a perspective of the stacking machine having a vertical support column 88 connected to said frame 13 assembly. The handling arm 85 is pivotally connected to said vertical supporting column 88 and is further displaceable in a vertical direction in relation to said vertical supporting column. The handling arm 85, is shown connected to the vertical support column 88 via support column sliding bars. This arrangement enables the handling arm to slide in a vertical direction in relation to the vertical support column and at the same time being pivotally connected to the support column. The vertical slideable and pivotally connection, allows the handling arm to swing across the delivery table for contacting the sheets 28 individually which is illustrated in FIG. 10A and transferring the sheets 28 individually from said delivery table by swinging the handling arm 85 from above the delivery table as illustrated in FIG. 10B to above the receiving area illustrated in FIG. 10C for releasing the sheets 28 individually on a pallet 83 arranged at the receiving area. Further, as the handling arm 85 is arranged vertical slideable on the vertical supporting column 88, the transfer station is able to transfer the sheets 28 from the level of the delivery table, to a lower level, e.g. a surface level of a pallet, placed at a floor level as illustrated in FIG. 10C.

The holding members 86 (not shown in FIG. 10A-10C) for lifting the sheets 28, which holding members 86 may comprise vacuum lifters, are attached to a holding member support 87, which is pivotally connected to one end of the handling arm, and the other opposite end of the handling arm 85 is connected to the vertical support column 88.

### REFERENCE NUMBERS

sheet dispensing system 10
guide roller 12
frame assembly 13
supporting frame 14
reel loading station 20
supporting frame column 21
underframe 211
castor wheels 213
supply reel 22
paper based material 23
supporting roller 25
finger of the supporting roller 251
reel sensor 26
support arm 27
sheet 28
first guide roller 31
second guide roller 32
guide plate 33
mounting plate 34
slots 35
lever 36
sheet dispenser station 40
sheet dispenser housing 41
housing covers 42
top wall 43,
bottom wall 44
side wall 45
side wall cover 46
motor 47
feeding mechanism 50
tension roller 51
feeding roller 52
tensioning handle 53
linkage mechanism 54
cutting mechanism 60
cutter assembly 61
guide rod 62
sledge 63
guide bushing 64
pulling cable 65
delivery station 70
delivery table 71
supporting column 711
conveying means 72
sensor 74
transfer station 80
receiving area 81
receiving assembly 82
platform, pallet 83
gantry 84
handling arm 85
holding member 86
holding member support 87
vertical support column 88
support column sliding bars 89
supporting column 811
scissor mechanism 821
controller 90
cable 92
computer 94
smoothing mechanism 100, 200, 300, 400, 500, 600
primary guide roller 210a, 210b,
secondary guide roller 212
main frame 214
pivot axis 216
first frame plate 218a
second frame plates 218b
reel loading station 302
underframe 310
linkage rods 311
first linkage rod 311a
second linkage rod 311b
first guide roller 312
second guide roller 314
castor wheel 315
linkage lever 316
locking element 317
bushing 318
supporting rollers 410
first guide rollers 412
second guide roller 414
recess 416
first roller 502
second roller 504
delivery table 506
guide roller 508
smoothing angle 510
delivery table 601
roller 602 603
first feeding roller 604
second feeding roller 605
common axis 606
smoothing angle 608
first guide roller 610
second guide roller 612

### Points Describing Features of the Invention

1. A sheet dispensing system for dispensing individual sheets, said sheet dispensing system comprising a frame assembly, a reel loading station, a sheet dispenser station, and a delivery station,
said reel loading station, said sheet dispenser station, and said delivery station being supported individually or collectively by said frame assembly,
said reel loading station including a supply reel of a cellulose fiber based web and a support for supporting said supply reel and allowing the dispensing of said cellulose fiber based web from said supply reel,
said sheet dispenser station including a feeding mechanism and a cutting mechanism,
said feeding mechanism serving to receive said cellulose fiber based web from said reel loading station and having a tension roller and a feeding roller,
said cutting mechanism having a reciprocating cutter assembly for cutting said cellulose fiber based web into individual sheets when moved transversally relative to said cellulose fiber based web from a first position to a second position at opposite sides of said cellulose fiber based web and being prevented from cutting when moved in the opposite direction from said second position to said first position,
said delivery station including a delivery table connected to said sheet dispenser station for receiving said individual dispensed sheets, and
said reel loading station or said sheet dispenser station or delivery station further comprising a smoothing mechanism having a first guide roller and second guide roller, said first and second guide rollers being adjustable in relation to one another for altering the smoothing angle dependent of the diameter of said supply reel in order to compensate for the curvature of said cellulose fiber based web and provide non-curved individual sheets.

2. The sheet dispensing system according to point 1, said cutting mechanism being prevented from cutting when moved in the opposite direction from said second position to said first position.

3. The sheet dispensing system according to point 1, said cutting mechanism cutting when moved in the opposite direction from said second position to said first position.

4. The sheet dispensing system according to point 2 or 3, said first and second guide rollers being adjustable in relation to one another for altering the smoothing angle by a mechanical suspension of the first guide roller and/or second guide.

5. The sheet dispensing system according to point 2 or 3, said first and second guide rollers being adjustable in relation to one another for altering the smoothing angle by a mechanical coupling between the first guide roller and second guide roller.

6. The sheet dispensing system according to point 2 or 3, said first and second guide rollers being adjustable in relation to one another for altering the smoothing angle by the provision of an electronic controller controlling said first and second rollers in relation to one another in response to an electrical signal generated by a sensor mounted on the loading station or the delivery station.

7. The sheet dispensing system according to point 6, said controller having an input channel and an out signal, said controller being capable of receiving a signal from a reel sensor connected to said reel loading station for generating said electrical signal being representative of the diameter of said supply reel.

8. The sheet dispensing system according to any of the proceeding points, said cellulose fiber based web being movable continuously, and said cutting mechanism being movable reciprocating parallel with and in synchronism with said cellulose fiber based web during the cutting of said cellulose fiber based web into said individual sheets.

9. The sheet dispensing system according to any of the proceeding points, said cellulose fiber based web being movable intermittently and said cutting mechanism being movable transversally relative to said cellulose fiber based web during the cutting of said cellulose fiber based web into said individual sheets.

10. The sheet dispensing system according to any of the proceeding points, said cutter assembly of the cutting mechanism being constituted by a blade, a mechanical roller knife or a laser cutter.

11. The sheet dispensing system according to any of the proceeding points, said smoothing mechanism comprises a first second guide roller being mounted on a guide plate, which is pivotally connected to a mounting plate connected with the side wall of the sheet dispenser station housing.

12. The sheet dispensing system according to point 11, said mounting plate having an arc portion with slots extending the width of said mounting plate, said slots are arranged near the circumference of the arc shape of said mounting plate, a lever with biasing means is arranged perpendicular on said guide plate, said lever is provided with a pin being substantially longer than the width of said guide plate, this will allow said lever to provide an interlocking of said guide plate relative to the mounting plate.

13 A method of dispensing individual sheet by means of a sheet dispensing system comprising a frame assembly, a reel loading station, a sheet dispenser station, and a delivery station, said method comprising the following steps:
providing said frame assembly for individually or collectively supporting said reel loading station, said sheet dispenser station and said delivery station,
providing said reel loading station including a supply reel of a cellulose fiber based web and a support for supporting said supply reel,
providing said sheet dispenser station including a feeding mechanism and a cutting mechanism,
providing said feeding mechanism having a tension roller and a feeding roller,
providing said cutting mechanism having a reciprocating cutter assembly,
providing said delivery station connected to said sheet dispenser station,
providing a smoothing mechanism having a first guide roller and second guide roller at said reel loading station or said sheet dispenser station or said delivery station,
dispensing said cellulose fiber based web to said feeding mechanism serving to receive said cellulose fiber based web from said reel loading station
cutting said cellulose fiber based web by moving said reciprocating cutter transversally relative to said cellulose fiber based web from a first position to a second position at opposite sides of said cellulose fiber based web and preventing cutting when moving said reciprocating cutter in the opposite direction from said second position to said first position,
adjusting said first or second guide rollers being adjustable in relation to one another, said guide rollers being adjustable for altering the smoothing angle dependent of the diameter of the supply reel in order to compensate for the curvature of said cellulose fiber based web and provide non-curved individual sheets.
dispensing said individual sheets on said delivery table of said delivery station

14. A method according to point 13 further including any of the features of the system according to any of the points 2-12.

1-16: (canceled)

17. A stacking machine for handling individual sheets, the stacking machine comprising:
a frame assembly including a plurality of support columns;
a delivery station supported by at least some of the plurality of support columns and having a delivery table defining a first horizontal plane, wherein the delivery table is configured for receiving and presenting the sheets individually;
a transfer station supported by at least some of the plurality of support columns and including a handling arm that is movable from a first position above the delivery table to a second position above a receiving area, the handling arm including holding members configured for contacting the sheets individually, for transferring the sheets individually from the delivery table to the receiving area, and for releasing the sheets individually at the receiving area.

18. The stacking machine of claim 17, wherein the handling arm is suspended by the frame assembly, the handling arm resting on at least some of the plurality of support columns at one end and being connected to the delivery station at an opposite end, whereby the transfer station spans the width of the delivery station.

19. The stacking machine of claim 18, wherein the transfer station includes a gantry that spans at least half a dimension of the delivery station perpendicular to the width of the delivery station, and that is movable along the width of the delivery station.

20. The stacking machine of claim 17, wherein the transfer station comprises a vertical support column connected to the frame assembly, and wherein the handling arm is pivotally connected to the vertical support column and is vertically displaceable in relation to the vertical support column.

21. The stacking machine of claim 17, further comprising a receiving assembly arranged in the receiving area and having a platform configured for collecting the individual sheets.

22. The stacking machine claim 17, wherein each of the holding members includes vacuum lifters located at the perimeter of the handling arm, wherein the vacuum lifters are configured for transferring the sheets.

23. The stacking machine of claim 21, wherein the receiving assembly includes a linkage mechanism that supports the platform and that is configured for enabling the platform to be moved vertically from a first level to a second level, the first level being substantially in the same horizontal plane as the first horizontal plane of the delivery table, and the second level being located parallel with and below the first horizontal plane of the delivery table, so as to allow the sheets to be stacked on top of the one another, and wherein the linkage mechanism is connected to an actuator.

24. The stacking machine of claim 17, wherein the transfer station is connected to a controller that is configured for allowing operation of the transfer station in communication with at least one of the delivery station and the receiving assembly.

25. The stacking machine of claim 17, wherein the delivery station includes a sensor arranged for detecting the presence and location of an individual sheet being received on the delivery table defining a first horizontal plane.

26. The stacking machine of claim 17, further comprising a sheet dispensing system configured for dispensing individual sheets, the sheet dispensing system comprising:
a second frame assembly supporting a reel loading station, a sheet dispenser station, and the delivery station;
the reel loading station comprising a supply reel containing a supply of cellulose fiber-based web, and a reel support configured for supporting the supply reel and for allowing the dispensing of the cellulose fiber-based web from the supply reel;
the sheet dispenser station including a feeding mechanism and a cutting mechanism, the feeding mechanism configured for receiving the cellulose fiber-based web from the reel loading station and including a tension roller and a feeding roller;
the cutting mechanism including a reciprocating cutter assembly configured for (a) cutting the cellulose fiber-based web into individual sheets when the cutter assembly is moved transversally relative to the cellulose fiber-based web from a first position to a second position at opposite sides of the cellulose fiber-based web, and (b) being prevented from cutting the cellulose fiber-based web when the cutter assembly is moved from the second position to the first position; and
the delivery station including a delivery table connected to the sheet dispenser station and configured for receiving the individual dispensed sheets;
wherein one of the reel loading station, the sheet dispenser station, and the delivery station further comprises a smoothing mechanism including a first guide roller and second guide roller, the first and second guide rollers being adjustable in relation to one another for altering a smoothing angle in response to changes in diameter of the supply of cellulose fiber-based web on the supply reel in order to compensate for changes in curvature of the supply of cellulose fiber-based web, thereby to provide non-curved individual sheets.

27. A method of stacking individual sheets, the method comprising the steps of:
(a) providing a stacking machine including a delivery station and a transfer station, the delivery station having a delivery table defining a first horizontal plane, the transfer station including a handling arm;
(b) providing a receiving assembly having a platform configured for collecting the individual sheets;
(c) delivering the sheets individually onto the delivery table;
(d) moving the handling arm from a first position above the delivery table to a second position above the receiving assembly;
(e) activating the holding members to contact each of the sheets individually;
(f) transferring the sheets individually from the delivery table to the receiving assembly;
(g) releasing the sheets individually at the receiving assembly;
(h) moving the platform vertically from a first level to a second level, the first level being substantially in the same horizontal plane as the first horizontal plane of the delivery table, and the second plane level located parallel with and below the first horizontal plane, whereby the sheets are allowed to be stacked on top of the one another.

28. The method of claim 27, wherein, in the step (c) of delivering, the sheets are delivered continuously on the delivery table; and wherein in the step (f) of transferring, the sheets are individually transferred from the delivery table to the receiving assembly synchronized with the sheets being delivered individually to the delivery table.

29. The method of claim 27, wherein, in the step (c) of delivering, the sheets are delivered intermittently on the delivery table, and wherein the step (f) of transferring comprises the steps of:
(f)(1) detecting the presence of sheets on the delivery table; and
(f)(2) transferring the sheets on the delivery table to the receiving assembly by stopping the delivery of the sheets during the step of transferring the sheets to the receiving assembly.

30. A method of stacking individual sheets the method comprising the steps of:
(a) providing a stacking machine including a delivery station and a transfer station, the delivery station having a delivery table defining a first horizontal plane, the transfer station including a handling arm including holding members, the stacking machine further comprising a reel loading station and a sheet dispenser station; wherein the reel loading station includes a supply reel containing a supply of a cellulose fiber-based web; wherein the sheet dispenser station includes a feeding mechanism and a cutting mechanism, the feeding mechanism having a tension roller and a feeding roller, the cutting mechanism including a reciprocating cutter assembly;
(b) providing a receiving assembly having a platform configured for collecting the individual sheets;
(c) providing a smoothing mechanism having a first guide roller and a second guide roller at one of the reel loading station, the sheet dispenser station, and the delivery station;
(d) dispensing the cellulose fiber-based web to the feeding mechanism from the reel loading station;
(e) cutting the cellulose fiber-based web by moving the reciprocating cutter assembly transversally relative to the cellulose fiber-based web from a first position to a second position at opposite sides of said cellulose fiber based web, and preventing cutting when the reciprocating cutter assembly is move from the second position to the first position;
(e) adjusting at least one of the first guide roller and the second guide roller to alter a smoothing angle depending on the diameter of the supply of the cellulose fiber-based web on the supply reel in order to compensate for the curvature of the supply of the cellulose fiber-based web on the supply reel, thereby to provide non-curved individual sheets;
(f) dispensing the individual sheets onto delivery table of the delivery station;
(g) moving the handling arm from the first position to the second position;
(h) activating the holding members of the handling arm to contact the sheets individually;
(i) transferring the sheets individually from the delivery table to the receiving area with the handling arm;
(j) activating the holding members to release the sheets individually onto the platform; and
(k) moving the platform vertically from a first level to a second level, the first level being substantially in the same horizontal plane as the first horizontal plane of the delivery table, and the second level being located parallel with and below the first horizontal plane for stacking the individual sheets on top of the one another.
